(19) United States
(12) Patent Application Publication
(10) Pub. No.: US 2007/0202830 A1
(43) Pub. Date: Aug. 30, 2007

(54) SPURIOUS TONE SUPPRESSOR AND METHOD OF OPERATION THEREOF

(75) Inventors: Khurram Muhammad, Dallas, TX (US); Chih-Ming Hung, McKinney, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/679,119

(22) Filed: Feb. 26, 2007

Related U.S. Application Data
(60) Provisional application No. 60/776,592, filed on Feb. 24, 2006.

(51) Int. Cl. H04B 1/10

(52) U.S. Cl. 455/298

(57) ABSTRACT

The present invention provides a spurious tone suppressor for use with a power supply system. In one embodiment, the spurious tone suppressor includes an error signal generator configured to provide a spur error signal proportional to a spur signal associated with the power supply system. Additionally, the spurious tone suppressor also includes an adaptive spur cancellation engine coupled to the error signal generator and configured to adaptively process the spur error signal and generate a corresponding anti-spur signal that is injected into the power supply system to suppress the spur signal.

### CROSS-REFERENCE TO PROVISIONAL APPLICATION

This application claims the benefit of U.S. Provisional Application No. 60/776,592 entitled “A Method for Spur Cancellation by Injecting Anti-Spur in the Power Supply System” to Khurram Muhammad and Chih-Ming Hung, filed on Feb. 24, 2006, which is incorporated herein by reference in its entirety.

### TECHNICAL FIELD OF THE INVENTION

The present invention is directed, in general, to signal processing and, more specifically, to a spurious tone suppressor and a method of operating a spurious tone suppressor.

### BACKGROUND OF THE INVENTION

The demand for wireless products has been growing in recent years resulting in intensive efforts to develop single chips that have reduced cost, power dissipation and chip size. As chip size is scaled downward, interactions between the various subsystems become increasingly problematic due to their closer proximity and reduced geometries. This is especially true for systems such as wireless transceivers, which require processing of low level and high frequency signals in an environment where digital signals are also employed.

Power distribution systems for these environments are also becoming more complex since the primary power source is usually a battery voltage that must be converted into several different supply voltages. Each of these supply voltages involves a voltage regulator (often referred to as a “low dropout” or LDO) that provides isolation between the supply voltages as well as a very stable output voltage. For these battery-based systems, power management has become a key design issue since extended operating time is often a highly desirable feature in a portable device.

Appropriate power management usually requires that the voltage regulators be switched regulators rather than linear regulators, since they are more efficient. For example, a linear regulator may take an input battery voltage of five volts and provide a regulated output voltage of 1.8 volts. Since the current drawn by the LDO load also passes through the regulator, this example requires that 3.2 volts be dropped across the regulator thereby wasting the significant portion of the power supplied to the regulator. The wasted power would be generated as heat thereby contributing to other system problems, as well.

Additionally, if the LDO is linear, it may supply power to a load that requires periodic delivery of this power to it. Hence, the output of the LDO has a periodic current surge, which may also appear as a periodic current surge at the input of the LDO and couple to the outputs of other LDOs connected to the same power source.

Switching regulators are therefore often preferred for power management since the majority of the power supplied to the switched voltage regulator is delivered to the intended load, and regulator dissipation is greatly reduced. Switched voltage regulators, although more efficient, generate spurious signals in the power distribution system at the switching frequency. These spurious signals are referred to as “spurs”, which may be defined as an unwanted tone (i.e., a signal of significant amplitude at substantially a single frequency or a very narrow band of frequencies). Spurs are particularly damaging to overall performance in areas that process low level and high frequency signals.

Accordingly, what is needed in the art is a more effective and efficient way to alleviate disturbances in power supply systems that arise from periodic delivery of energy or spurious signal generation.

### SUMMARY OF THE INVENTION

To address the above-discussed deficiencies of the prior art, the present invention provides a spurious tone suppressor for use with a power supply system. In one embodiment, the spurious tone suppressor includes an error signal generator configured to provide a spur error signal proportional to a spur signal associated with the power supply system. Additionally, the spurious tone suppressor also includes an adaptive spur cancellation engine coupled to the error signal generator and configured to adaptively process the spur error signal and generate a corresponding anti-spur signal that is injected into the power supply system to suppress the spur signal.

In another aspect, the present invention provides a method of operating a spurious tone suppressor for use with a power supply system. The method includes providing a spur error signal proportional to a spur signal associated with the power supply system. The method also includes adaptively processing the spur error signal to generate a corresponding anti-spur signal and injecting the corresponding anti-spur signal into the power supply system to suppress the spur signal.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a transceiver as provided by one embodiment of the present invention;

FIG. 2 illustrates an embodiment of a transceiver power module as may be employed in the transceiver of FIG. 1;

FIG. 3 illustrates an embodiment of a spurious tone suppressor constructed according to the principles of the present invention;

FIG. 4 illustrates an embodiment of a spur suppression driver constructed according to the principles of the present invention;

FIG. 5 illustrates an embodiment of an amplitude compensator as may be employed in the in-phase spur suppression driver of FIG. 4; and

FIG. 6 illustrates a method of operating a spurious tone suppressor carried out according to the principles of the present invention.

### DETAILED DESCRIPTION

Embodiments of the present invention employ an adaptive spur cancellation technique, which injects a desired frequency signal of controlled amplitude and phase into a power system. The injected signal is determined by amplitude and phase components derived from in-phase (I) and quadrature-phase (Q) drive signals. Overall strength of these I and Q components determine the amplitude of cancellation energy provided to the power system, and relative strengths between these I and Q components determine the phase of the cancellation signal. Any of a plurality of potentially spur-generating clocking frequencies, employed within equipment supported by the power supply system, may be selected as an appropriate spur cancellation frequency. Additionally, an error signal representative of the spur signal may be derived from a plurality of collection points within the equipment. The error signal is then adaptively driven towards zero until the spur signal is forced to an acceptably low level.

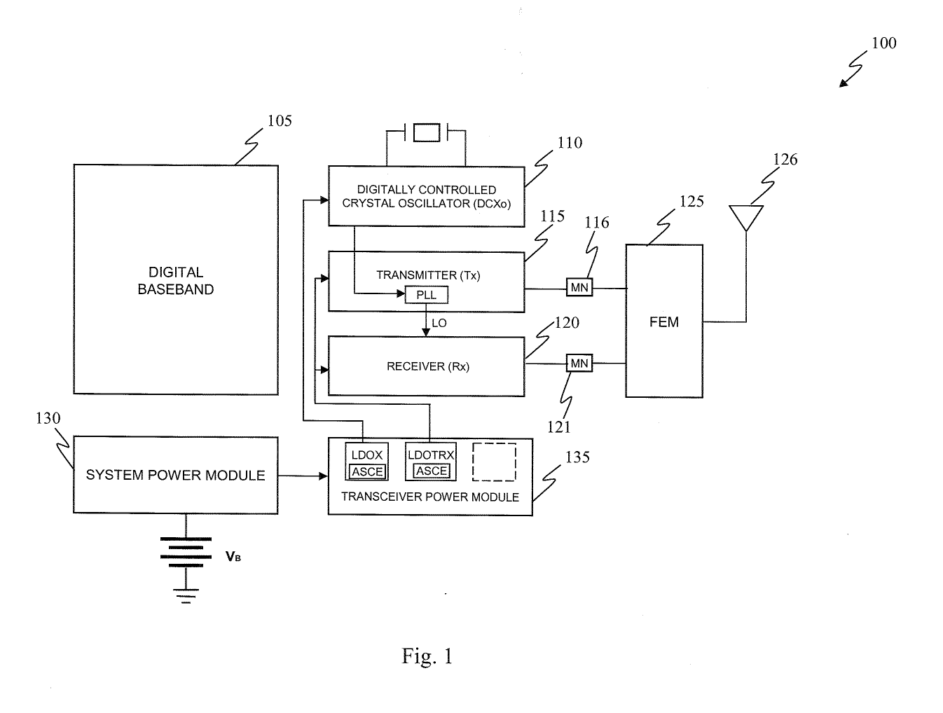

FIG. 1 illustrates a transceiver, generally designated 100, as provided by one embodiment of the present invention. The transceiver 100 includes a digital baseband unit 105, a digitally controlled crystal oscillator (DCXO) 110, a transmitter (Tx) 115 and a receiver (Rx) 120. The transmitter 115 and the receive 120 employ first and second matching networks (MN) 116, 121 coupled to a front end module (FEM) 125 that is in turn coupled to an antenna 126. The transceiver 100 also includes a system power module 130 coupled to a battery V_{B}, and a transceiver power module 135 coupled to the system power module 130. The transceiver power module 135 provides power to the digitally controlled crystal oscillator 110, the transmitter 115 and the receiver 120. The digitally controlled crystal oscillator 110 drives a phase locked loop (PLL) in the transmitter 115, which in turn provides a local oscillator (LO) for the receiver 120.

In the illustrated embodiment, the transceiver power module 135 includes a plurality of voltage regulators (LDOs), wherein an LDOX and an LDOTRX are shown. The LDOX regulates the voltages for the digitally controlled crystal oscillator 110, and the LDOTRX regulates the voltages for the transmitter 115 and the receiver 120. The transceiver power module 135 receives a switched input voltage from the system power module 130, which generates a spur at the power supply switching frequency. In the illustrated embodiment, the spur associated with this switched input voltage is periodic with a frequency of about three MHz. This spur propagates throughout the transceiver 100, mainly through the grounding system associated with the transceiver power module 135. Each of the LDOs in the transceiver power module 135 employs an adaptive spur cancellation engine (ASCE) to suppress this spur (or other spurs as required).

Other spurs may be generated due to the periodic supply of energy at a particular frequency. As an example, LDOX provides power to the reference system for the phase locked loop, which, for many standards, is at a frequency of 26 MHz. Naturally, a frequency component at 26 MHz is introduced into the power system of the transceiver 100. A spur at 26 MHz frequency and its harmonics may be observed at the output of LDOTRX.

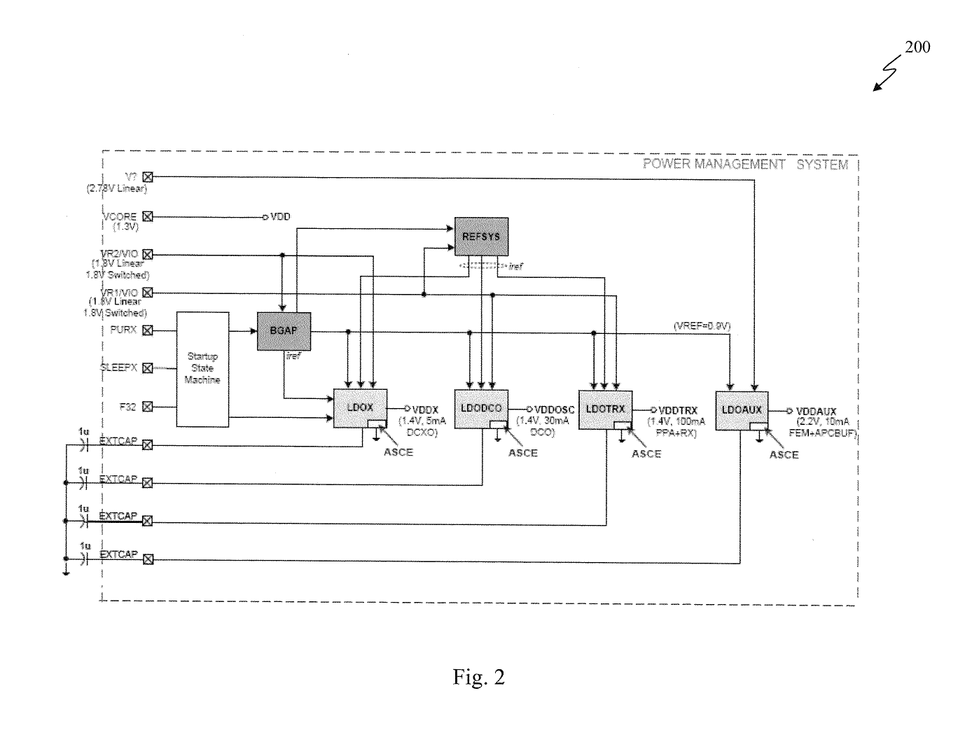

FIG. 2 illustrates an embodiment of a transceiver power module, generally designated 200, as may be employed in the transceiver of FIG. 1. The transceiver power module 200 is an integrated power module that includes a plurality of LDOs. In the illustrated embodiment the plurality of LDOs includes LDOX, LDODCO, LDOTRX and LDOAUX. Each of these LDOs is actually a different power domain, which is supplying power to individual circuits or subsystems. For example, the LDOX, supplies regulated voltages to the DCXO and the LDOTRX supplies to some part of the transmitter and the receiver, as noted. Then, the LDODCO supplies to the phase lock loop, and the LDOX supplies to another unit not shown in FIG. 1.

In the illustrated embodiment, separate ASCEs are employed in each LDO. However, they could be combined into fewer units if most of the spur is being coupled through the grounding system. Alternatively, if the spur is propagating through both the power distribution system and the grounding system, then separate ASCEs are probably required.

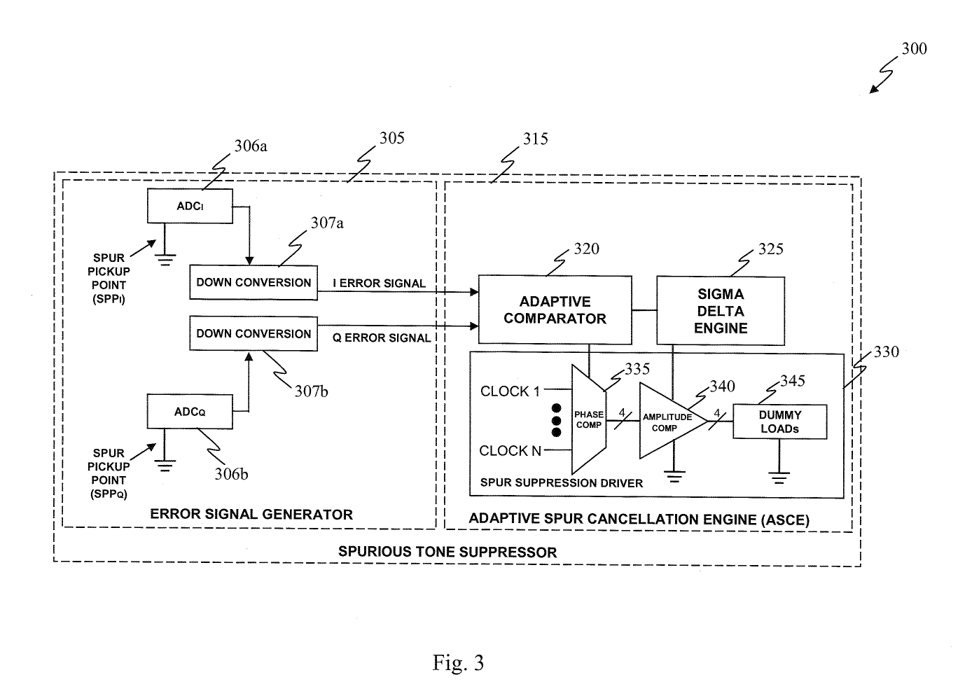

FIG. 3 illustrates an embodiment of a spurious tone suppressor, generally designated 300, constructed according to the principles of the present invention. The spurious tone suppressor 300 includes an error signal generator 305 and an ASCE 315. The error signal generator 305 includes in-phase and quadrature-phase analog to digital converters (ADCs) 306a, 306b and respective down converters 307a, 307b. The ASCE 315 includes an adaptive comparator 320, a sigma delta engine 325 and a spur suppression driver 330.

The spurious tone suppressor 300 is for use with a power supply system, such as those previously discussed. The error signal generator 305 is configured to provide a spur error signal that is proportional to a spur signal associated with the power supply system. Additionally, the ASCE 315 is coupled to the error signal generator 305 and is configured to adaptively process the spur error signal and generate a corresponding anti-spur signal that is injected into the power supply system to suppress the spur signal.

In the illustrated embodiment, the in-phase and quadrature phase ADCs 306a, 306b are associated with a receiver such as the receiver 120 of FIG. 1. The in-phase and quadrature phase ADCs 306a, 306b employ the in-phase and quadrature-phase spur pickup points SPP_{I}, SPP_{Q} of the grounding system to provide a digital representation of the offending spur signal. The down converters 307a, 307b provide DC in-phase and quadrature-phase components of a spur error signal to the adaptive comparator 320.

The spur may be picked up at a node in the system that is known to carry the spur. The signal at this node is converted from analog to digital and the spur down-converted to DC. The analog-to-digital conversion is done in a quadrature manner, where two ADC clocks are phase shifted by 90 degrees to form in-phase and quadrature “complex error” signals. It is also possible to interchange the order of the analog-to-digital conversion and the following down-conversion. That is, the signal at the node known to contain the spur signal may be down-converted to DC using a quadrature local oscillator signal and then followed by the analog-to-digital conversion that would yield the digital representation of the “complex error” signal.

Alternatively, in-phase and quadrature-phase spur pickup points could be provided by the phase detector of the phase locked loop employed in a transmitter such as the transmitter 115 of FIG. 1, since it will contain any spur signal. If the power supply system or something else produces a perturbation at a certain frequency, the phase error detects it. If the phase error were an analog quantity, it could be converted to a digital signal and employed as previously discussed. As described earlier, this error signal may alternatively be down-converted using quadrature down-conversion with quadrature local oscillators at the spur frequency and then analog-to-digital converted to provide the error signal.

If a digital phase lock loop is employed, the phase error is a digital quantity that may be used directly. Therefore, the phase error is also a good source for understanding where spurs are located in the frequency spectrum. In this case, analog-to-digital conversion is not necessary since the digital phase error signal already contains the spur information in the digital domain. In this case, the digital phase error is digitally down-converted to zero-IF using a quadrature down-conversion method and fed to the following adaptive comparator 320. Of course, one skilled in the pertinent art will recognize that there are other places within a system where spur content may be quantified and converted from analog to digital.

In the case of a switching regulator producing a spur, an ADC drawing its power from such a regulator produces a spur at its output at the same frequency while converting any input from analog to digital. Examples of such a case are the ADCs processing the signal received by the receiver 120. The ADCs this receiver will easily reproduce the spurs in the power supply system to spurs in the digital output. These spurs can be isolated using a bandpass filter and furnished to the adaptive comparator 320 as an error signal. Alternatively these can be down-converted, low-pass filtered and furnished to the adaptive comparator 320.

The adaptive comparator 320 employs the in-phase and quadrature-phase components of the spur signal to adaptively process the spur error signal. In the illustrated embodiment, the spur error signal is processed employing software and firmware programs. However, other embodiments may employ a hardwired program for processing. Adaptively processing the spur error signal may employ at least one of several algorithms that are well known to one skilled in the pertinent art. For example, processing may employ a zero forcing algorithm, a mean square error reduction algorithm or a least square algorithm to force the spur error signal below a predetermined level.

The sigma delta engine 325 receives an adaptively processed spur error signal from the adaptive comparator 320 and enables buffers that drive dummy loads having four-phase clock signals at desired frequencies. The frequencies of the clock signals are generated based on the knowledge of spur locations. One example of such a frequency is the ripple in the switched-mode regulator, while a second frequency example may be the frequency produced by the DCXO 110 of FIG. 1. Other known frequencies that produce spurs may also be used as possible inputs for driving the buffers. Examples of these would be frequencies that are known to clock a large number of digital gates, which may degrade the performance of a transmitter or a receiver.

The sigma delta engine 325 converts the complex error signal to a one-bit, over-sampled, sigma-delta modulated output bit stream whose average value represents the complex DC error signal. The sigma-delta engine 325 may be replaced by a pulse-width modulator or any other well known over-sampling technique that converts a multi-bit input signal to an over-sampled one-bit output stream.

The spur suppression driver 330 includes a phase compensator 335 and an amplitude compensator 340 that provides drive signals to dummy loads 345. The phase compensator 335 consists of four multiplexers that supply each of four phases for any of the clock frequencies used in equipment associated with the power supply system. In the illustrated embodiment, the equipment is a transceiver supported by the power supply system, and the four phases provided are 0, 90, 180 and 270 degrees (corresponding to I+, Q+, I− and Q−).

Each of these phases drives an individual buffer in the amplitude compensator 340. Hence, the sigma delta engine 335 is enabled by the adaptive comparator 320 to select the four phases of the clock frequency that needs to be suppressed, while the four outputs of the sigma delta engine 335 drive individual buffers in the amplitude compensator 340. Enablement of these four buffers are generated by the I+, Q+, I− and Q− data from the one-bit sigma-delta modulator to drive the buffers associated with 0, 90, 180 and 270 degree clocks furnished by the phase compensator 335. Therefore, the spur suppression driver 330 allows injection of the corresponding anti-spur signal into the grounding portion of the power supply system employing any phase and amplitude and at any clock frequency that is determined by the adaptive processing of the adaptive comparator 320.

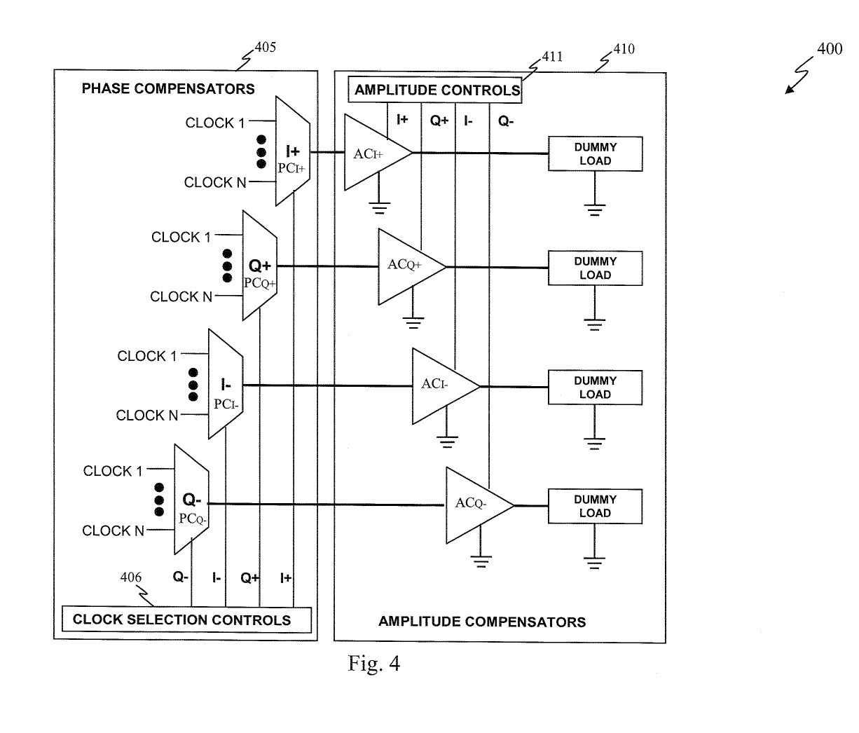

FIG. 4 illustrates an embodiment of a spur suppression driver, generally designated 400, constructed according to the principles of the present invention. The spur suppression driver 400 provides an expanded view of the spur suppression driver 330 of FIG. 3. The spur suppression driver 400 includes phase compensators 405 having a multiplexer for each of the four phases corresponding to the phase compensator 335 of FIG. 3. Clock selection controls 406 determine which of the N clocks is selected.

The spur suppression driver 400 also includes amplitude compensators 410 having a four buffer unit corresponding to each phase provided by the phase compensators 405. Amplitude controls 411 corresponding to the four phases determine the amplitude of each of the phase components of the corresponding anti-spur signal that is applied to the grounding system through each of the respective dummy loads.

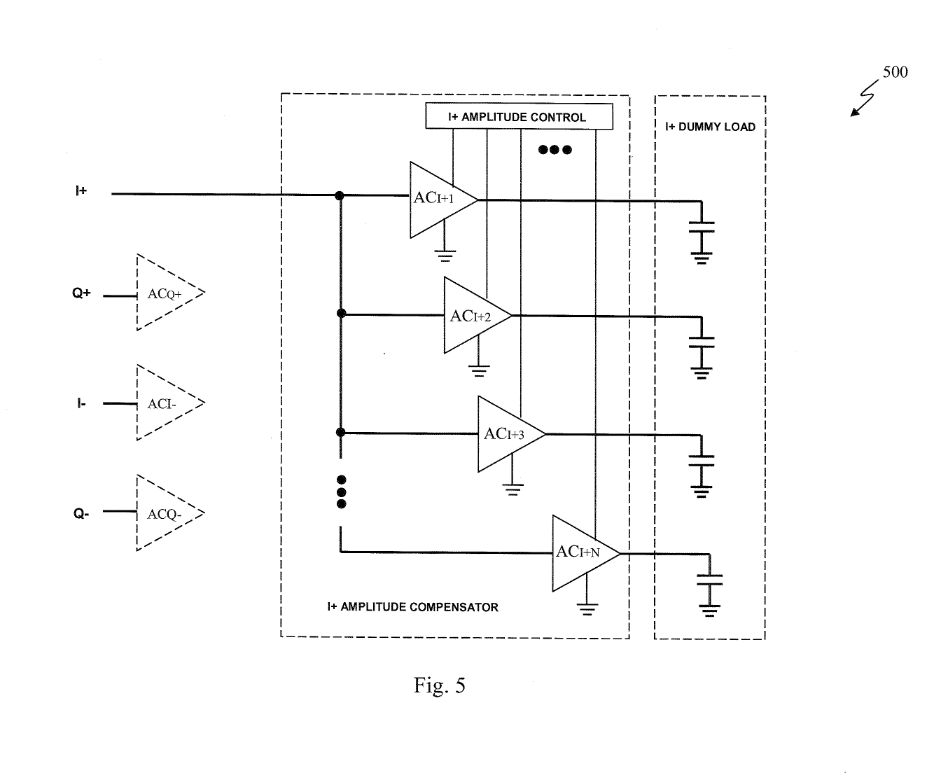

FIG. 5 illustrates an embodiment of an amplitude compensator, generally designated 500, as may be employed in the in-phase spur suppression driver of FIG. 4. The in-phase (I+) amplitude compensator 500 is exemplary of each of the other amplitude compensators (Q+, I−, Q−) and includes a plurality of individual buffers that provide drive signals to individual capacitors employed as individual dummy loads. In the illustrated embodiment, the I+ amplitude control determines how many of the individual buffers are providing a drive signal to their corresponding load capacitors, and therefore the total corresponding anti-spur signal strength of the I+ phase component. Amplitude compensators for the remaining phases employ a similar plurality of individual buffers, wherein the collective amplitudes of all buffers employed determine the strength and resulting phase of the corresponding anti-spur signal applied to the grounding system.

The amplitude control for the I+ input, as shown in FIG. 5, illustrates that oversampling is not essential to achieving resolution in amplitude. Each bit of amplitude may directly control a buffer whose drive level represents the weight of the amplitude bit. For example, a three bit amplitude will drive three buffers sized 4×, 2× and 1×. The most significant bit will drive the buffer sized 4× while the least significant bit will drive the buffer sized 1×. This concept may be applied to an N-bit amplitude. The buffers represent digital-to-analog conversion, and any of the well-known approaches of segmentation of digital-to-analog converters (DACs) can be utilized in embodiments of this invention. This DAC consists of buffers driving dummy loads, which convert the digital input to an impulse in the power supply system that is coherent with the clock signal driving the buffer.

It is also possible to segment the amplitude control into two parts. One part drives a Nyquist DAC such that reasonable sized buffers are needed to do the digital-to-analog conversion. The remaining part is fed to a sigma-delta modulator that converts the digital signal to an oversampled, noise-shaped, single-bit or multi-bit output signal that drives an appropriate numbers of buffers. Of course, the relative sizes of the buffers need to be appropriately chosen. With this partitioning, high resolution digital-to-analog conversion is possible without requiring construction of a nonrealizable DAC consisting of too many buffers.

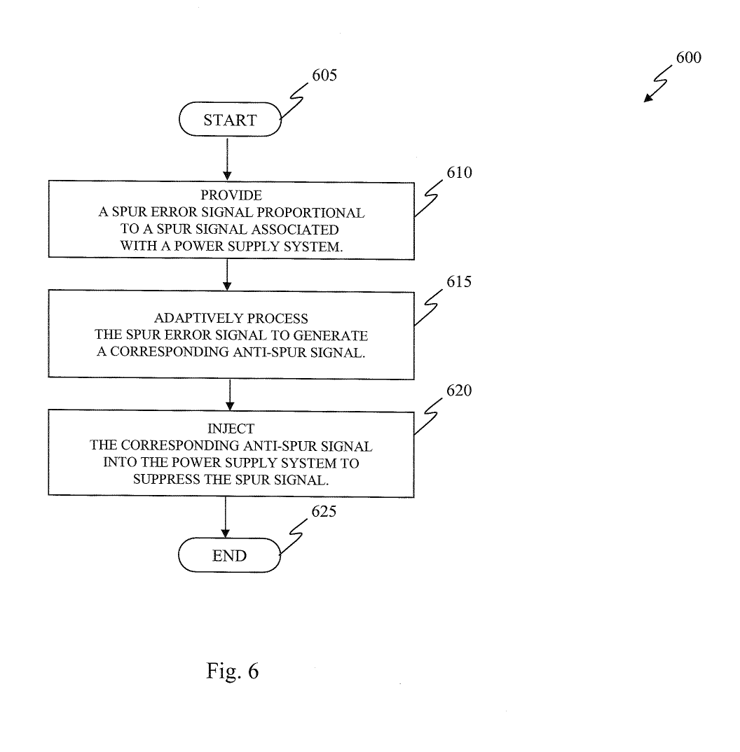

FIG. 6 illustrates a method of operating a spurious tone suppressor, generally designated 600, carried out according to the principles of the present invention. The method 600 is for use with a power supply system and starts in a step 605. Then, in a step 610, a spur error signal is provided that is proportional to a spur signal associated with a power supply, and the spur error signal is adaptively processed to generate a corresponding anti-spur signal in a step 615.

Adaptively processing the spur error signal employs in-phase and quadrature-phase components of the spur signal. Additionally, adaptively processing the spur error signal employs one selected from the group consisting of a software program, a firmware program and a hardwired program. Further, adaptively processing the spur error signal also employs one selected from the group consisting of a zero forcing algorithm, a mean square error reduction algorithm and a least square algorithm to reduce the spur error function. In one embodiment, a delta sigma engine is employed in generating or injecting the corresponding anti-spur signal.

The corresponding anti-spur signal is injected into the power supply system to suppress the spur signal in a step 620. In one embodiment of the invention, the corresponding anti-spur signal suppresses the spur signal at a switching frequency of the power supply system. In an alternative embodiment, the corresponding anti-spur signal is provided at any one of a plurality of clock frequencies associated with equipment supported by the power supply system, such as a transceiver.

In one embodiment, the corresponding anti-spur signal is injected in a ground portion of the power supply system employing a at least one capacitor as a dummy load. Typically, a plurality of individual dummy loads is employed to provide a collective dummy load. Injecting the corresponding anti-spur signal into the power supply system generally employs in-phase and quadrature-phase drive signals, which allow tailoring of the amplitude and phase of the corresponding anti-spur signal into the dummy load.

While the method disclosed herein has been described and shown with reference to particular steps performed in a particular order, it will be understood that these steps may be combined, subdivided, or reordered to form an equivalent method without departing from the teachings of the present invention. Accordingly, unless specifically indicated herein, the order or the grouping of the steps is not a limitation of the present invention.

Those skilled in the art to which the invention relates will appreciate that other and further additions, deletions, substitutions and modifications may be made to the described embodiments without departing from the scope of the invention.

What is claimed is:

1. A spurious tone suppressor for use with a power supply system, comprising:
an error signal generator configured to provide a spur error signal proportional to a spur signal associated with the power supply system; and
an adaptive spur cancellation engine coupled to the error signal generator and configured to adaptively process the spur error signal and generate a corresponding anti-spur signal that is injected into the power supply system to suppress the spur signal.

2. The suppressor as recited in claim 1 wherein adaptively processing the spur error signal employs in-phase and quadrature-phase components of the spur signal.

3. The suppressor as recited in claim 1 wherein adaptively processing the spur error signal employs one selected from the group consisting of:
a software program;
a firmware program and
a hardwired program.

4. The suppressor as recited in claim 1 wherein adaptively processing the spur error signal employs one selected from the group consisting of:
a zero forcing algorithm;
a mean square error reduction algorithm; and
a least square algorithm.

5. The suppressor as recited in claim 1 wherein the corresponding anti-spur signal suppresses the spur signal at a switching frequency of the power supply system.

6. The suppressor as recited in claim 1 wherein the corresponding anti-spur signal is provided at any one of a plurality of clock frequencies associated with equipment supported by the power supply system.

7. The suppressor as recited in claim 1 wherein generating the corresponding anti-spur signal employs a delta sigma engine.

8. The suppressor as recited in claim 1 wherein the corresponding anti-spur signal is injected in a ground portion of the power supply system.

9. The suppressor as recited in claim 1 wherein injecting the corresponding anti-spur signal into the power supply system provides in-phase and quadrature-phase drive signals.

10. The suppressor as recited in claim 9 wherein the in-phase and quadrature-phase drive signals provide tailoring of the amplitude and phase of the corresponding anti-spur signal.

11. The suppressor as recited in claim 9 wherein each of the in-phase and quadrature-phase drive signals employs a dummy load to inject the corresponding anti-spur signal into the power supply system.

12. The suppressor as recited in claim 11 wherein the dummy load is a capacitor.

13. A method of operating a spurious tone suppressor for use with a power supply system, comprising:
providing a spur error signal proportional to a spur signal associated with the power supply system;
adaptively processing the spur error signal to generate a corresponding anti-spur signal; and
injecting the corresponding anti-spur signal into the power supply system to suppress the spur signal.

14. The method as recited in claim 13 wherein adaptively processing the spur error signal employs in-phase and quadrature-phase components of the spur signal.

15. The method as recited in claim 13 wherein adaptively processing the spur error signal employs one selected from the group consisting of:
a software program;
a firmware program and
a hardwired program.

16. The method as recited in claim 13 wherein adaptively processing the spur error signal employs one selected from the group consisting of:
a zero forcing algorithm;
a mean square error reduction algorithm; and
a least square algorithm.

17. The method as recited in claim 13 wherein the corresponding anti-spur signal suppresses the spur signal at a switching frequency of the power supply system.

18. The method as recited in claim 13 wherein the corresponding anti-spur signal is provided at any one of a plurality of clock frequencies associated with equipment supported by the power supply system.

19. The method as recited in claim 13 wherein generating the corresponding anti-spur signal employs a delta sigma engine.

20. The method as recited in claim 13 wherein the corresponding anti-spur signal is injected in a ground portion of the power supply system.

21. The method as recited in claim 13 wherein injecting the corresponding anti-spur signal into the power supply system provides in-phase and quadrature-phase drive signals.

22. The method as recited in claim 21 wherein the in-phase and quadrature-phase drive signals provide tailoring of the amplitude and phase of the corresponding anti-spur signal.

23. The method as recited in claim 21 wherein each of the in-phase and quadrature-phase drive signals employs a dummy load to inject the corresponding anti-spur signal into the power supply system.

24. The method as recited in claim 23 wherein the dummy load is a capacitor.
